(19) United States
(12) Patent Application Publication
(10) Pub. No.: US 2026/0118297 A1
(43) Pub. Date: Apr. 30, 2026

(54) MAGNETIC PROPERTY MEASUREMENT METHOD AND MAGNETIC PROPERTY MEASUREMENT DEVICE FOR SOFT MAGNETIC MATERIAL

(71) Applicant: Hitachi, Ltd., Tokyo (JP)

(72) Inventors: Teruo KOHASHI, Tokyo (JP); Masanari KOGUCHI, Tokyo (JP)

(21) Appl. No.: 19/297,308

(22) Filed: Aug. 12, 2025

(30) Foreign Application Priority Data
Oct. 31, 2024 (JP) 2024-191691

(51) Int. Cl. G01N 24/00

(52) U.S. Cl. CPC G01N 24/006

(57) ABSTRACT

A magnetic property measurement device for a soft magnetic material includes a measurement sample magnetic field application mechanism, a diamond NVC sensor, a laser light irradiation mechanism, a microwave irradiation mechanism, an optically detected magnetic resonance spectrum measurement mechanism, and a control and data analysis mechanism, the control and data analysis mechanism is configured to execute a measurement condition input step, a magnetic property measurement step, and a data analysis step, the measurement condition includes a range of an external magnetic field H₀, a magnetic permeability μₛₘₚ of a measurement sample, and a predetermined frequency sweep width Δω in a microwave, and the predetermined frequency range of the microwave in the magnetic property measurement step is a region of “ω_{d}±Δω” based on a microwave frequency ω_{d} of the dip obtained from a relational expression of “ω_{d}=2.87±28×μₛₘₚ×H₀”.

### CLAIM OF PRIORITY

The present application claims priority from Japanese patent application serial no. 2024-191691 filed on Oct. 31, 2024, the content of which is hereby incorporated by reference into this application.

### BACKGROUND OF THE INVENTION

### 1. Field of the Invention

The present invention relates to a technique for measuring material properties, and more particularly to a magnetic property measurement method for a soft magnetic material and a measurement device for performing the measurement method.

### 2. Description of Related Art

In recent years, from the viewpoint of protecting the global environment, there has been a trend toward expanding fields of application of electromechanical devices (such as rotating electric machines and transformers) that use iron cores, and as a result, there has been a strong demand for higher output, higher efficiency, and smaller size for these electromechanical devices. As an iron core of the electromechanical device, a stacked iron core formed by stacking a plurality of soft magnetic material plates (for example, having a thickness of 0.01 mm to 3 mm) is widely used.

When a rotating electric machine is assumed as the electromechanical device, an output thereof is proportional to the product of a torque and a rotation speed during operation, and therefore, the output can be increased by increasing either the torque or the rotation speed. The torque is proportional to the product of the magnetic flux density and the current value. To increase the torque, it is desirable to use a soft magnetic material that achieves a high saturation magnetic flux density Bs and/or a high saturation magnetization Ms. To increase Bs/Ms, various compositions and microstructures of the soft magnetic material are controlled.

When increasing the rotation speed during operation, the efficiency of the conversion between electrical energy and magnetic energy is important, and reducing losses (iron losses Pi) in the soft magnetic material becomes a challenge. The reduction in Pi also leads to a reduction in heat generation during operation. Pi is a sum of a hysteresis loss and an eddy current loss, to reduce the hysteresis loss, it is desirable to have a small coercive force Hc and to reduce the eddy current loss, and it is effective to increase electrical resistance (for example, alloying) or reduce the eddy current area (for example, making the plate thinner).

In the related art, measurement using a vibrating sample magnetometer (VSM) or the Epstein method has been widely used to measure a magnetic property. However, the measurement of the magnetic property using the VSM or the Epstein method has the disadvantages of having an accuracy of about ±0.1%, and there are limitations on the sample shapes that can be measured. From the viewpoint of developing soft magnetic materials with higher performance, it is desirable to have a measurement method that can measure the magnetic property with accuracy higher than that in the measurement using the VSM and the Epstein method in the related art. Naturally, it is desirable that there are few limitations on the shape sample that can be measured.

In response to such demands, a quantum magnetic sensor that uses an electron spin quantum state of nitrogen-vacancy centers (NVCs) in diamond crystals has been attracting attention in recent years due to features of excellent magnetic detection sensitivity and spatial resolution.

For example, PTL 1 (JP2021-152473A) discloses a device configuration in which the NVC is applied to a magnetic memory inspection.

### CITATION LIST

### Patent Literature

PTL 1: JP2021-152473A

### Non Patent Literature

NPL 1: Takayuki Iwasaki, Applied Physics, 89, 196-202 (2020)
NPL 2: Julia Michl, Tokuyuki Teraji, Sebastian Zaiser, Ingmar Jakobi, Gerald Waldherr, Florian Dolde, Philipp Neumann, Marcus W. Doherty, Neil B. Manson, Junichi Isoya, Jorg Wrachtrup, Appl. Phys. Lett. 104, 102407 (2014).
NPL 3: P. Maletinsky, S. Hong, M. S. Grinolds, B. Hausmann, M. D. Lukin, R. L. Walsworth, M. Loncar and A. Yacobyi, Nature NanoTachnology 7, pp. 320-324 (2012).

### SUMMARY OF THE INVENTION

The quantum magnetic sensor (hereinafter, referred to as a “diamond NVC sensor”) using the electron spin quantum state of the nitrogen-vacancy center (NVC) in the diamond crystal described above has an excellent feature of accuracy higher than that of the measurement using the VSM or the Epstein method in the related art by an order of one digit (about ±0.01%).

However, the magnetic property measurement using the diamond NVC sensor has a disadvantage in that the time required for measurement is longer (for example, 20 times to 30 times longer) than that of the measurement using the VSM or the Epstein method in the related art by an order of one digit or larger. In other words, the magnetic property measurement using the diamond NVC sensor has been considered to be unsuitable for measurement with a large number of samples.

To effectively utilize the attractive feature of the diamond NVC sensor having high measurement accuracy, the inventors have worked diligently to develop technology for measuring the magnetic property using the diamond NVC sensor. Therefore, a primary object of the invention is to provide a measurement method and a measurement device capable of significantly reducing the time required for measurement as compared with that in the related art in magnetic property measurement using a diamond NVC sensor.

(I) One aspect of the invention is a magnetic property measurement method for a soft magnetic material performed by using a diamond NVC sensor, and the magnetic property measurement method for a soft magnetic material includes:
a measurement condition input step of inputting a measurement condition of the magnetic property;
a magnetic property measurement step of, according to the measurement condition, applying an external magnetic field to a measurement sample of the soft magnetic material, irradiating the diamond NVC sensor disposed in the vicinity of the measurement sample with green laser light and a microwave in a predetermined frequency range, and detecting red fluorescence from the diamond NVC sensor to measure a dip of an optically detected magnetic resonance spectrum; and
a data analysis step of obtaining a center frequency of the dip and calculating the magnetic field of the measurement sample in the external magnetic field based on the center frequency, in which
the measurement condition includes a range of the external magnetic field H₀ [unit: A/m], a magnetic permeability μₛₘₚ [unit: T·m/A] of the measurement sample, and a predetermined frequency sweep width Δω in the microwave, and
the predetermined frequency range of the microwave in the magnetic property measurement step is a region of “ω_{d}±Δω” based on a microwave frequency ω_{d} [unit: GHz] of the dip obtained from a relational expression of “ω_{d}=2.87±28×μₛₘₚ×H₀” in an environment of 20° C.

(II) Another aspect of the invention is a measurement device for a magnetic property of a soft magnetic material including:
a sample setting mechanism configured to set the soft magnetic material serving as a measurement sample;
a measurement sample magnetic field application mechanism configured to apply an external magnetic field to the measurement sample;
a diamond NVC sensor configured to detect a magnetic field of the measurement sample;
a laser light irradiation mechanism configured to irradiate the diamond NVC sensor with green laser light;
a microwave irradiation mechanism configured to irradiate the diamond NVC sensor with a predetermined microwave;
an optically detected magnetic resonance spectrum measurement mechanism configured to detect red fluorescence from the diamond NVC sensor and measure an optically detected magnetic resonance spectrum; and
a control and data analysis mechanism configured to control the measurement sample magnetic field application mechanism, the laser light irradiation mechanism, and the microwave irradiation mechanism, and perform data analysis based on the optically detected magnetic resonance spectrum measured by the optically detected magnetic resonance spectrum measurement mechanism, in which
the control and data analysis mechanism is configured to execute
   a measurement condition input step of inputting a measurement condition of the magnetic property,
   a magnetic property measurement step of, according to the measurement condition, performing application and control of the external magnetic field on the measurement sample, performing irradiation and control of the green laser light and the microwave on the diamond NVC sensor, and performing measurement of a dip of the optically detected magnetic resonance spectrum caused by the red fluorescence from the diamond NVC sensor, and
   a data analysis step of obtaining a center frequency of the dip and calculating the magnetic field of the measurement sample in the external magnetic field based on the center frequency,
the measurement condition includes a range of the external magnetic field H₀ [unit: A/m], a magnetic permeability μₛₘₚ [unit: T·m/A] of the measurement sample, and a predetermined frequency sweep width Δω in the microwave, and
the predetermined frequency range of the microwave in the magnetic property measurement step is a region of “ω_{d}±Δω” based on a microwave frequency ω_{d} [unit: GHz] of the dip obtained from a relational expression of “ω_{d}=2.87±28×μₛₘₚ×H₀” in an environment of 20° C.

In the invention, the following improvements and modifications can be freely combined and added to the magnetic property measurement method for a soft magnetic material (I) and the magnetic property measurement device (II) according to the invention.

(i) The measurement condition input step is executed by being divided into
a measurement condition partial input substep of inputting a measurement condition other than the magnetic permeability μₛₘₚ of the measurement sample,
an optically detected magnetic resonance spectrum preliminary measurement substep of, based on the measurement condition in the measurement condition partial input substep, applying the external magnetic field to the measurement sample, measuring the dip of the optically detected magnetic resonance spectrum while irradiating the diamond NVC sensor with the green laser light and the microwave, and obtaining a center frequency of the dip, and
a sample magnetic permeability calculation substep of calculating the magnetic permeability μₛₘₚ of the measurement sample based on the applied external magnetic field, the obtained center frequency of the dip, and the relational expression.

(ii) The measurement condition further includes a frequency sweep speed of the microwave,
the external magnetic field in the optically detected magnetic resonance spectrum preliminary measurement substep is at least one magnetic field selected from a range of 20% or more and 80% or less of an external magnetic field input in the measurement condition partial input substep, and
irradiation with the microwave in the optically detected magnetic resonance spectrum preliminary measurement substep is performed at a speed of 5 times or more and 10 times or less the frequency sweep speed input in the measurement condition partial input substep.

(iii) The magnetic property measurement step is executed on “only a region on a side less than 2.87 GHz” or “only a region on a side larger than 2.87 GHz” of the dip caused by Zeeman splitting.

(iv) The predetermined frequency sweep width Δω is 0.01 GHz or more and 0.05 GHz or less.

According to the invention, a measurement method and a measurement device capable of significantly reducing the time required for measurement as compared with that in the related art in magnetic property measurement using a diamond NVC sensor can be provided. The problems, configurations, and effects other than those described above will become apparent from the following description of the embodiment.

### BRIEF DESCRIPTION OF THE DRAWINGS

FIG. 1 is a schematic diagram illustrating a crystal lattice of diamond having a nitrogen-vacancy center (NVC), and is a schematic diagram illustrating an example of a state of detecting red fluorescence by optically detected magnetic resonance (ODMR);

FIG. 2 is a schematic diagram illustrating a basic concept of magnetic measurement using a diamond NVC sensor in the invention;

FIG. 3 is a schematic diagram illustrating a configuration example of a magnetic property measurement device for a soft magnetic material according to the invention;

FIG. 4 is an enlarged schematic diagram illustrating an example in which a thin-film-shaped diamond NVC sensor is disposed adjacent to or in close contact with a measurement sample;

FIG. 5 is an enlarged schematic diagram illustrating an example in which a probe-shaped diamond NVC sensor is disposed adjacent to the measurement sample;

FIG. 6 is a schematic diagram illustrating an example of a display screen of an output device of a control and data analysis mechanism;

FIG. 7 is a flowchart illustrating an example of a magnetic property measurement process using the measurement device of the invention;

FIG. 8 is a flowchart illustrating another example of the magnetic property measurement process using the measurement device of the invention;

FIG. 9 is a schematic diagram illustrating an example of results (a magnetization curve and an ODMR spectrum) obtained by performing magnetic property measurement according to the invention on a commercially available permalloy; and

FIG. 10 is a schematic diagram illustrating an example of results (a magnetization curve and an ODMR spectrum) obtained by performing magnetic property measurement according to the invention on a commercially available permendur.

### DESCRIPTION OF EMBODIMENTS

### Basic Concept of Invention

First, a magnetization curve (also referred to as an M-H curve or a B-H curve) which is a basis of magnetic property measurement will be briefly described. When an external magnetic field is applied to a magnetic material sample in a non-magnetic state, the magnetic material sample is magnetized. When the external magnetic field becomes strong, the magnetization of the sample also monotonically increases, and the magnetization of the sample is saturated at a certain level. The magnetization at this time is referred to as saturation magnetization Ms, and a magnetic flux density is referred to as saturation magnetic flux density Bs.

When the external magnetic field is decreased from the saturation magnetization Ms, the magnetization of the sample also monotonically decreases but often follows a line different from that when the external magnetic field is increased. This phenomenon is called hysteresis. A magnetic material having a large hysteresis is referred to as a hard magnetic material or a hard magnet and is suitably used as a magnet. A magnetic material having a small hysteresis is referred to as a soft magnetic material or a soft magnet and is suitably used as an iron core. Since a hysteresis loss of the iron loss Pi is proportional to an area of a hysteresis curve, it is desirable for the area of the hysteresis curve to be as small as possible (ideally a curve with an area of zero) from the viewpoint of iron loss Pi.

Next, magnetic measurement using the diamond NVC sensor will be briefly described.

Diamond NVC is a type of lattice defect in which some of carbon (C) atoms in a diamond crystal are substituted with nitrogen (N) atoms, and vacancy is generated at positions adjacent to the N atoms due to a difference in atomic valence. The diamond NVC has a special property of easily capturing electrons and becoming negatively charged, and of being able to stably maintain a quantum state of spin even at room temperature. For example, see NPL 1.

When the diamond NVC is irradiated with green laser light (with a wavelength of 532 nm), the diamond NVC absorbs the energy and the spin transitions from a ground state to an excited state, and then returns to an original ground level while emitting red fluorescence (with a wavelength of 637 nm). At this time, when the diamond NVC is irradiated with microwaves of various frequencies while being irradiated with the green laser light and an amount of the emitted red fluorescence is measured, it is known that resonance occurs at a specific microwave frequency (2.87 GHz at a temperature of 20° C.), reducing an amount of the detected red fluorescence.

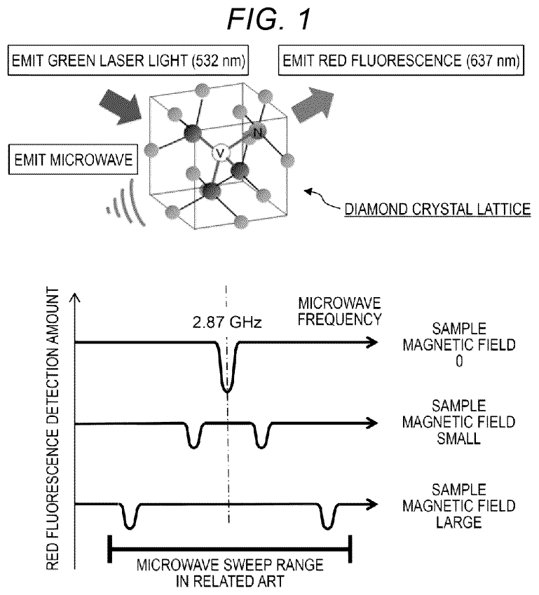

This phenomenon is called optically detected magnetic resonance (ODMR), and a minimum point of the detection amount of the red fluorescence is called a dip. FIG. 1 is a schematic diagram of a crystal lattice of diamond having an NVC, and is a schematic diagram illustrating an example of a state of detecting the red fluorescence by the ODMR.

The dip is one of specific frequencies (2.87 GHz under an environment of 20° C.) when a sample magnetic field applied to the diamond NVC (a leakage magnetic field emitted from the measurement sample corresponding to an amount of magnetization of the measurement sample) is zero, but is separated into two when the sample magnetic field is applied to the diamond NVC (more precisely, in a direction parallel to an N-V axis in the diamond crystal). This phenomenon is called Zeeman splitting. A magnitude (a frequency difference from 2.87 GHZ) of the Zeeman splitting is proportional to a magnitude of the sample magnetic field. A proportionality constant in the Zeeman splitting is called a gyromagnetic ratio and is known to be 28 GHZ/T. In other words, by precisely measuring the magnitude of the Zeeman splitting (the frequency difference from 2.87 GHZ), the sample magnetic field (in a direction parallel to the N-V axis) applied to the diamond NVC can be precisely measured.

In a diamond single crystal, the N-V axis can take four directions due to the crystal structure thereof. Therefore, in a single crystal diamond NVC sensor in which the N-V axis is not particularly oriented, a total of four Zeeman splitting (a total of eight dips) are observed along the magnitude of the sample magnetic field detected by each of the N-V axes in the four directions. In other words, there is also a feature that the sample magnetic field applied to the single crystal diamond NVC sensor can be three-dimensionally analyzed by precisely measuring the magnitudes of a total of four Zeeman splitting.

Hereinafter, in the present specification, one Zeeman splitting (two dips) will be described to simplify the description and facilitate understanding.

The magnetization measurement in the related art using the diamond NVC sensor is roughly as follows.

(1) A sample magnetic field is held and stabilized in a certain state.

(2) A diamond NVC sensor adjacent to the sample is irradiated with green laser light.

(3) The diamond NVC sensor is irradiated with green laser light and the microwave frequency is swept while irradiating the diamond NVC sensor with microwaves, and the amount of red fluorescence emitted from the diamond NVC sensor is measured to determine the microwave frequency at which a dip occurs. In other words, the frequency of the irradiated microwave is swept until the dip is sufficiently observed.

(4) A numerical value of the sample magnetic field is calculated from the microwave frequency at which the dip occurs.

(5) The sample magnetic field is changed to the next state, and the processing returns to (1).

In this procedure, the process (3) takes the longest time. To precisely measure the magnetization curve, it is naturally desirable to minimize a change width of the sample magnetic field in the process (5).

For example, when the magnetization of the soft magnetic material sample is measured in a range of “−20 mT⇔20 mT” (a cycle of 0 mT→20 mT→0 mT→−20 mT→0 mT→20 mT) in an increment of 1 mT, in the magnetization measurement using the diamond NVC sensor in the related art, since the sweep frequency width of the microwave is set to cover all the dips by the Zeeman splitting in ±20 mT, it is estimated that about 800 minutes in total is required.

On the other hand, when the magnetization measurement in the same range is performed by the VSM or the Epstein method, 30 minutes is required. In the magnetization measurement using the diamond NVC sensor in the related art, the length of time required for the measurement is considered not to be at an easily acceptable level even when there is a one-digit advantage in magnetization measurement accuracy.

Therefore, to effectively utilize an extremely attractive feature of the diamond NVC sensor having high measurement accuracy, the inventors have diligently studied technology for magnetic property measurement using the diamond NVC sensor. As a result, it has been found that, by effectively utilizing the high measurement accuracy, the frequency sweep width of microwaves to be irradiated in the process (3) can be significantly reduced, and the time required for measurement can be significantly reduced as compared with that in the related art. The invention has been completed based on this finding.

Hereinafter, an embodiment of the invention will be described with reference to the drawings. The invention is not limited to the specific embodiment described above and can be appropriately combined with known techniques or improved based on known techniques without departing from the technical idea of the invention.

### Principle of Magnetic Property Measurement for Soft Magnetic Material in Invention

In the measurement of the magnetic property, the magnetization of the measurement sample (sample magnetization) Mₛₘₚ [unit: T] is expressed by the following formula (1) from a magnetic permeability μₛₘₚ [unit: T·m/A] of the measurement sample and the external magnetic field (a magnetic field applied to the measurement sample, also referred to as a magnetomotive force) H₀ [unit: A/m].

$${M}_{s m p} = {μ}_{smp} \times {H}_{0} . \qquad Formula ( 1 )$$

As described above, a leakage magnetic field emitted from the measurement sample corresponding to the sample magnetization Mₛₘₚ is referred to as a sample magnetic field Hₛₘₚ [unit: A/m]. In a region where the sample magnetic field Hₛₘₚ is not diffused and attenuated (for example, in the vicinity of a surface of the measurement sample), the sample magnetic field Hₛₘₚ, the sample magnetization Mₛₘₚ, and a vacuum magnetic permeability μ₀ [unit: T·m/A] have the relationship of the following formula (2). In a magnetic property measurement method used in the invention, the sample magnetic field Hₛₘₚ is measured by disposing a diamond NVC sensor in the vicinity of the surface of the measurement sample.

$${M}_{s m p} = {μ}_{0} \times {H}_{s m p} . \qquad Formula ( 2 )$$

In addition, since the magnetic property measurement method of the invention is ODMR measurement for the soft magnetic material, the Zeeman splitting occurs as described above. A microwave frequency ω_{d} [unit: GHz] at a dip position caused by the Zeeman splitting is expressed by the following formula (3) from the gyromagnetic ratio 28 [unit: GHz/T], the vacuum magnetic permeability po, and the sample magnetic field Hₛₘₚ.

$${ω}_{d} = 2.87 \pm 28 \times {μ}_{0} \times {H}_{s m p} . \qquad Formula ( 3 )$$

From Formulas (1) to (3), the following formula (4) is established.

$${ω}_{d} = 2.87 \pm 28 \times {μ}_{smp} \times {H}_{0} . \qquad Formula ( 4 )$$

This means that, when an approximate value of the magnetic permeability μₛₘₚ of the measurement sample is known, the microwave frequency ω_{d} at the dip position can be estimated to some extent from the external magnetic field H₀ by placing the diamond NVC sensor adjacent to or in close contact with the measurement sample and measuring the sample magnetic field Hₛₘₚ without diffusive attenuation.

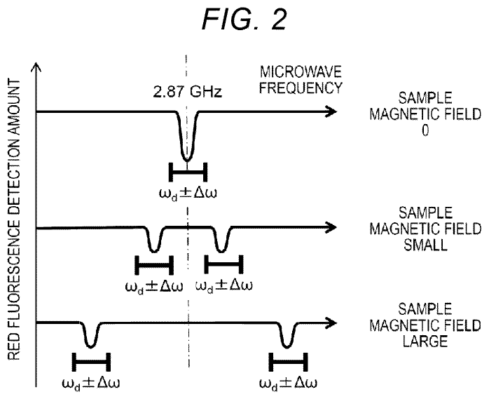

FIG. 2 is a schematic diagram illustrating a basic concept of magnetic measurement using the diamond NVC sensor in the invention. As illustrated in FIG. 2, if the microwave frequency ω_{d} at the dip position in the ODMR measurement can be estimated to some extent, a center frequency of the dip can be accurately measured even when the frequency sweep width of the microwave is limited to a region in the vicinity of the ω_{d} (for example, ω_{d}±Δω, Δω=0.01 GHz to 0.05 GHZ). In other words, by limiting the sweep frequency of the microwave to only the region in the vicinity of the ω_{d} for each setting of the sample magnetic field, the measurement time can be significantly reduced as compared with the case where the frequency sweep width is set to cover the entire deviation width of the dip caused by the Zeeman splitting.

Since the dip positions in the ODMR measurement are equally split into a positive side and a negative side around the microwave frequency of 2.87 GHZ (under an environment of 20° C.) by the Zeeman splitting, only one split side may be measured when the reduction of the measurement time is prioritized. When the measurement time is estimated under the same conditions as described above (in the range of “−20 mT⇔20 mT” at the increment of 1 mT), it is found that in the magnetization measurement method of the invention, the measurement time is reduced from about 800 minutes in the related art to about 28 minutes and is equal to or less than that in the case of using the VSM or the Epstein method.

When the measurement accuracy of the center frequency of the dip is prioritized (that is, when the measurement accuracy of the sample magnetic field is prioritized), it is desirable to perform the measurement on both the positive side and the negative side.

### Magnetic Property Measurement Device for Soft Magnetic Material According to Invention

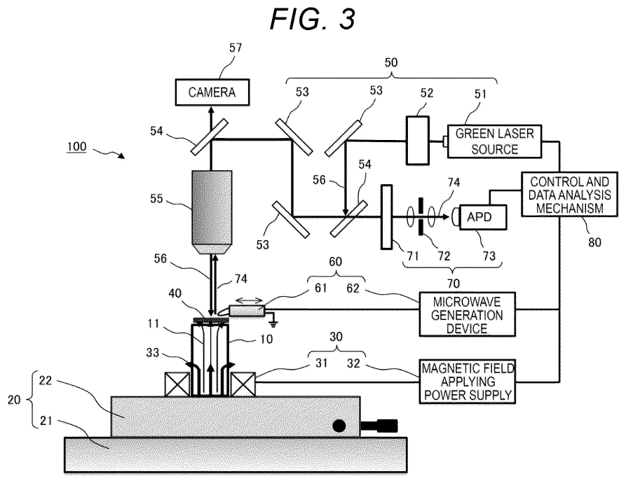

FIG. 3 is a schematic diagram illustrating a configuration example of a magnetic property measurement device for a soft magnetic material according to the invention.

As illustrated in FIG. 3, in a magnetic property measurement device 100 for a soft magnetic material according to the invention, a measurement sample 10 is set on a sample setting mechanism 20, and a measurement sample magnetic field application mechanism 30 that applies a magnetic field to the measurement sample 10 is disposed around the measurement sample 10. The sample setting mechanism 20 is not particularly limited as long as the measurement sample 10 can be stably set, and for example, an optical table 21 and a sample stage 22 can be suitably used. The measurement sample magnetic field application mechanism 30 is not particularly limited as long as a magnetic field can be applied to the measurement sample 10, and for example, an electromagnet 31 and a magnetic field applying power supply 32 can be suitably used. A sample magnetic field 11 occurs in the measurement sample 10 by the magnetic field (an external magnetic field 33) generated by the measurement sample magnetic field application mechanism 30. From the viewpoint of simplifying the drawings and facilitating understanding, the sample magnetization and the sample magnetic field are collectively referred to as the sample magnetic field 11.

A diamond NVC sensor 40 that detects the sample magnetic field 11 of the measurement sample 10 is disposed to be adjacent to or in close contact with the measurement sample 10. A shape of the diamond NVC sensor 40 is not particularly limited as long as the sample magnetic field 11 of the measurement sample 10 can be efficiently detected. For example, the diamond NVC sensor 40 may have a thin film shape as disclosed in NPL 2 or a probe shape as disclosed in NPL 3. FIG. 3 illustrates the diamond NVC sensor 40 having a thin film shape. When the shape of the diamond NVC sensor 40 is not particularly limited, the degree of freedom of a shape of the measurement sample 10 is increased (there are few restrictions on the shape of the measurement sample 10).

The magnetic property measurement device 100 includes, as measurement systems, a laser light irradiation mechanism 50 that irradiates the diamond NVC sensor 40 with the green laser light (with a wavelength of 532 nm), a microwave irradiation mechanism 60 that irradiates the diamond NVC sensor 40 with predetermined microwaves, and an optically detected magnetic resonance spectrum measurement mechanism 70 that detects red fluorescence (with a wavelength of 637 nm) from the diamond NVC sensor 40 and measures an optically detected magnetic resonance spectrum.

The laser light irradiation mechanism 50 illustrated in FIG. 3 includes a green laser source 51, an acousto-optic modulator (AOM) 52, a mirror 53, a half mirror 54, and an objective lens 55, and the diamond NVC sensor 40 is irradiated with green laser light 56 emitted from the green laser source 51. Although not an essential configuration, it is preferable to include a camera 57 such that a position of the diamond NVC sensor 40 and a position for laser light irradiation can be confirmed.

The microwave irradiation mechanism 60 includes, for example, a microwave antenna 61 and a microwave generation device 62. Arrangement conditions of the microwave antenna 61 are not particularly limited as long as the diamond NVC sensor 40 can be irradiated with a microwave 63, and for example, the microwave antenna 61 is preferably disposed within 100 mm from the diamond NVC sensor 40 (strictly speaking, from a measurement point of the magnetic property).

The optically detected magnetic resonance spectrum measurement mechanism 70 includes the objective lens 55, the half mirror 54, the mirror 53, a neutral density (ND) filter 71, a confocal pinhole 72, and an avalanche photodiode (APD) 73, and detects an amount of red fluorescence 74 emitted from the diamond NVC sensor 40 with the APD 73.

The magnetic property measurement device 100 further includes a control and data analysis mechanism 80 that controls the measurement sample magnetic field application mechanism 30, the laser light irradiation mechanism 50, and the microwave irradiation mechanism 60, and analyzes data from the optically detected magnetic resonance spectrum measured by the optically detected magnetic resonance spectrum measurement mechanism 70. The control and data analysis mechanism 80 includes a computer device (for example, a PC), an input device (for example, a keyboard, a mouse, or a touchpad), and an output device (for example, a display or a printer), and is connected to the measurement sample magnetic field application mechanism 30, the laser light irradiation mechanism 50, the microwave irradiation mechanism 60, and the optically detected magnetic resonance spectrum measurement mechanism 70.

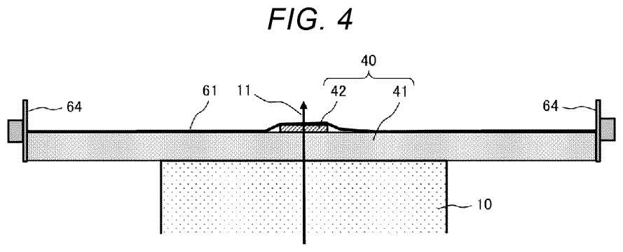

FIG. 4 is an enlarged schematic diagram illustrating an example in which a thin-film-shaped diamond NVC sensor is disposed adjacent to or in close contact with the measurement sample. In the example illustrated in FIG. 4, the diamond NVC sensor 40 has a structure in which a diamond NVC thin film 42 is disposed on a non-magnetic substrate 41 (for example, a glass substrate), and the entire diamond NVC sensor 40 is disposed to be adjacent to or in close contact with the measurement sample 10. The microwave antenna 61 connected to a connector 64 is disposed on the diamond NVC sensor 40. The thin-film-shaped diamond NVC sensor is advantageous from a viewpoint of measurement accuracy.

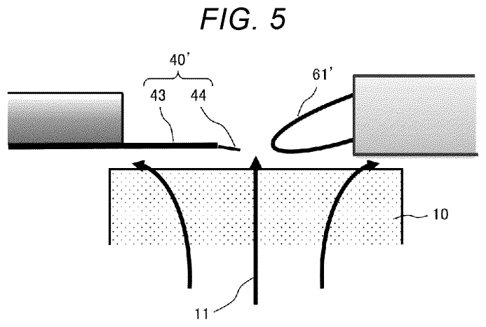

FIG. 5 is an enlarged schematic diagram illustrating an example in which a probe-shaped diamond NVC sensor is disposed adjacent to the measurement sample. In the example illustrated in FIG. 5, a diamond NVC sensor 40′ has a structure in which a diamond NVC probe 44 is disposed at a tip of a metal base 43 (for example, a tungsten base), and the diamond NVC probe 44 is disposed to be adjacent to the measurement sample 10. A microwave antenna 61′ is disposed in the vicinity of the diamond NVC sensor 40′. The probe-shaped diamond NVC sensor has an advantage in that it is advantageous for local data collection in the magnetization of the measurement sample 10 (collection of two-dimensional or three-dimensional magnetization data of the measurement sample 10).

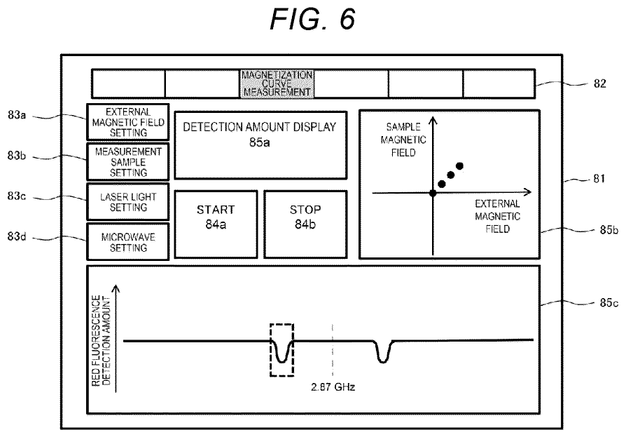

FIG. 6 is a schematic diagram illustrating an example of a display screen of the output device of the control and data analysis mechanism. In the example illustrated in FIG. 6, there is a menu bar 82 on an upper side of a display screen 81, and various measurement menus are listed. When one of the measurement menus is selected, various windows related to the selected measurement menu are opened below the menu bar 82.

For example, when magnetization curve measurement is selected as the measurement menu, an external magnetic field setting icon 83a, a measurement sample setting icon 83b, a laser light setting icon 83c, and a microwave setting icon 83d appear on the left side of the display screen 81.

When the external magnetic field setting icon 83a is clicked, a window for inputting a range (an upper limit and a lower limit) of the external magnetic field 33, a change width of the external magnetic field 33, and the like is opened. When the measurement sample setting icon 83b is clicked, a window for inputting the magnetic permeability μₛₘₚ, the saturation magnetization Ms, the saturation magnetic flux density Bs, and the like of the measurement sample 10 is opened. When the laser light setting icon 83c is clicked, a window for inputting an intensity of the green laser light 56 is opened. When the microwave setting icon 83d is clicked, a window for inputting an intensity, a sweep frequency width, a frequency sweep speed, the number of repetitions of measurement, and the like of the microwave 63 is opened.

When an external magnetic field setting, a measurement sample setting, a laser light setting, and a microwave setting (collectively referred to as “measurement conditions”) are input, a start button 84a and a stop button 84b for the magnetization curve measurement and a detection amount display 85a of the red fluorescence 74 become active. When the start button 84a is clicked, the magnetization curve measurement is started, a magnetization curve display 85b and an ODMR display 85c become active, and the measurement situation can be confirmed in real-time. When a set measurement sequence is completed, the measurement is automatically ended, but the measurement can be interrupted by clicking the stop button 84b.

### Measurement Process for Magnetic Property Using Measurement Device of Invention

Next, a measurement process of the magnetic property using the magnetic property measurement device 100 will be described.

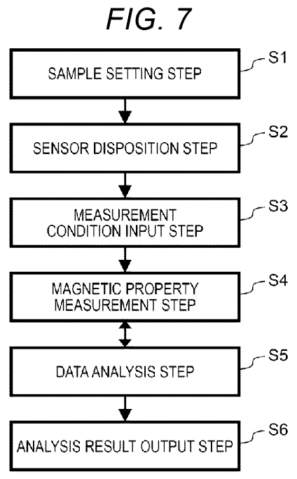

FIG. 7 is a flowchart illustrating an example of a measurement process for a magnetic property using the measurement device of the invention. As illustrated in FIG. 7, first, a sample setting step S1 of setting the measurement sample 10 in the sample setting mechanism 20 is performed. At this time, to correspond to the shapes of the measurement sample 10 and the measurement sample magnetic field application mechanism 30, the measurement sample 10 may be set in a place where the measurement sample magnetic field application mechanism 30 is disposed in advance, or the measurement sample magnetic field application mechanism 30 may be disposed later around the set measurement sample 10.

Next, a sensor disposition step S2 of disposing the diamond NVC sensor 40 to be adjacent or in close contact with the measurement sample 10 is performed. At this time, to correspond to the shapes of the measurement sample 10 and the diamond NVC sensor 40, the measurement sample 10 may be moved to a place where the diamond NVC sensor 40 is disposed in advance, or the diamond NVC sensor 40 may be disposed later on the set measurement sample 10.

Next, a measurement condition input step S3 of inputting measurement conditions of the magnetic property of the measurement sample 10 into the control and data analysis mechanism 80 is performed. As described above, the measurement conditions include the range and the change width of the external magnetic field 33, the magnetic permeability μₛₘₚ of the measurement sample 10, the intensity of the green laser light 56, the intensity, the frequency sweep width, and the frequency sweep speed of the microwave 63, and the number of repetitions of the magnetization curve measurement. Step S3 is not necessarily performed after step S2, and may be performed in any order as long as it is performed before the next magnetic property measurement step S4.

Next, according to the measurement conditions in the measurement condition input step S3, the magnetic property measurement step S4 is performed in which the application and control of the external magnetic field 33 are performed on the measurement sample 10, the irradiation and control of the green laser light 56 and the microwave 63 are performed on the diamond NVC sensor 40, and the dip of the ODMR is measured in the light amount measurement of the red fluorescence 74.

For example, when the frequency sweep width of the microwave 63 is set to “Δω=0.02 GHz”, when the external magnetic field 33 is “H₀=0 A/m” under an environment of 20° C., the dip of the ODMR is observed at “ω_{d}=2.87 GHz”, and thus the light amount measurement of the red fluorescence 74 may be performed in a range of “2.85 GHZ≤ω≤2.89 GHZ” which is “ω_{d}±Δω”. A frequency sweep width Δω of the microwave 63 is preferably 0.01 GHz or more and 0.05 GHz or less, and more preferably 0.015 GHz or more and 0.04 GHz or less.

Next, a data analysis step S5 is performed in which the control and data analysis mechanism 80 obtains the center frequency of the dip from the shape of the dip obtained from the light amount measurement data of the red fluorescence 74 and calculates the sample magnetic field Hₛₘₚ in the external magnetic field H₀ at that time from the center frequency. The sample magnetic field Hₛₘₚ can be calculated using the relationship in Formula (4) described above. When the sample magnetic field Hₛₘₚ in the external magnetic field H₀ at that time can be calculated, the process returns to the property measurement step S4 to perform measurement under the next external magnetic field condition.

When all pieces of measurement set in the measurement condition input step S3 are completed, an analysis result output step S6 of creating and outputting a magnetization curve of the measurement sample 10 is performed. The creation and output of the magnetization curve of the measurement sample 10 are not limited to be performed after all pieces of measurement are completed, and the creation and output may be performed at any time every time the data analysis step S5 is completed as described above.

A dip position “ω_{d}=2.87 GHZ” at a sample magnetic field of zero in the ODMR measurement is in an environment of 20° C., and it is known that the dip position is shifted by 0.00007 GHz every time the environmental temperature changes by 1° C. However, the shift caused by the environmental temperature is about 0.0024%/° C. and can be usually regarded as an error range. On the other hand, when a large crystallographic strain occurs in the diamond NVC sensor, it is known that the dip position in the ODMR measurement is shifted from the original position.

Therefore, a calibration step S0 (not illustrated) for confirming and calibrating the shift of the dip position caused by the environmental temperature or the crystallographic strain of the diamond NVC sensor may be performed. For example, the shift can be confirmed and calibrated by accurately measuring the environmental temperature of the measurement and the dip position at the sample magnetic field of zero in the ODMR measurement and measuring a difference from “ω_{d}=2.87 GHZ”. Step S0 is not an essential step, and may be appropriately performed as necessary. The sequence of step S0 may be incorporated in the control and data analysis mechanism 80 of the magnetic property measurement device 100.

### Another Example of Measurement Process for Magnetic Property Using Measurement Device of Invention

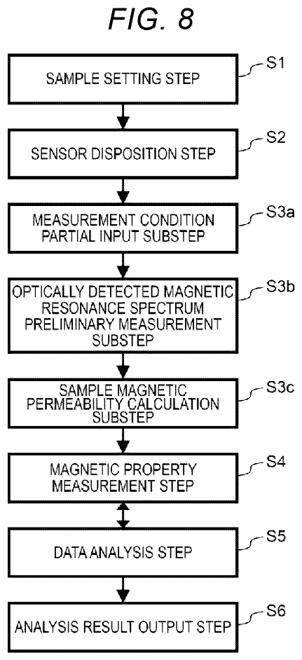

Here, a case where the approximate value of the magnetic permeability μₛₘₚ of the measurement sample 10 is not known in advance will be described. FIG. 8 is a flowchart illustrating another example of the magnetic property measurement process using the measurement device of the invention. As illustrated in FIG. 8, the sample setting step S1 and the sensor disposition step S2 are the same as the measurement process illustrated in FIG. 7.

Next, a measurement condition partial input substep S3a of inputting measurement conditions other than the magnetic permeability μₛₘₚ of the measurement sample 10 is performed. In other words, the measurement conditions other than the magnetic permeability μₛₘₚ of the measurement sample 10 are the same as those in the measurement process illustrated in FIG. 7.

Next, an optically detected magnetic resonance spectrum preliminary measurement substep S3b of performing ODMR spectrum measurement on the measurement sample 10 and obtaining the center frequency of the observed dip based on the measurement conditions in the measurement condition partial input substep S3a is performed. For example, at least one external magnetic field 33 selected from 20% to 80% in the range of the external magnetic field 33 input in the measurement condition partial input substep S3a is applied, and the green laser light 56 is emitted at the intensity of the input green laser light 56. The external magnetic field 33 to be applied is more preferably selected from 40% to 60% in the range of the external magnetic field 33 input in substep S3a.

The microwave 63 is emitted at the intensity of the microwave 63 input in the substep S3a, and the frequency sweep is performed until two dips of the ODMR are observed. The sweep speed at that time is preferably, for example, 5 times to 10 times the frequency sweep speed input in the substep S3a (high-speed sweep).

When the shapes of the two dips observed are relatively clear, the center frequency of the dip is obtained. On the other hand, when the shapes of the two observed dips are relatively unclear, a medium-speed sweep is performed at a speed of 2 times to 4 times the input frequency sweep speed, and the center frequency of the dip is obtained, limited to the frequency range of the observed dips (for example, limiting to a range of 0.02 GHz to 0.10 GHz to include the entire observed dips).

Next, a sample magnetic permeability calculation substep S3c of calculating the approximate value of the magnetic permeability μₛₘₚ of the measurement sample 10 is performed from the applied external magnetic field 33, the obtained dip center frequency, and the relationship of Formula (4) described above. The calculated approximate value is preferably automatically written into the measurement conditions as the magnetic permeability μₛₘₚ of the measurement sample 10. Accordingly, the same state as the measurement condition input step S3 illustrated in FIG. 7 is obtained.

The subsequent magnetic property measurement step S4 to analysis result output step S6 are the same as those in the measurement process illustrated in FIG. 7. In other words, the measurement process illustrated in FIG. 8 corresponds to that in FIG. 7 by dividing the measurement condition input step S3 into the substeps S3a to S3c described above.

### EXAMPLES

The invention will be described more specifically by actual measurement. However, the invention is not limited to the contents described below.

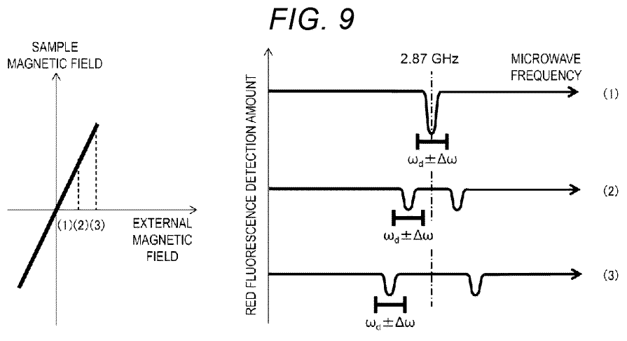

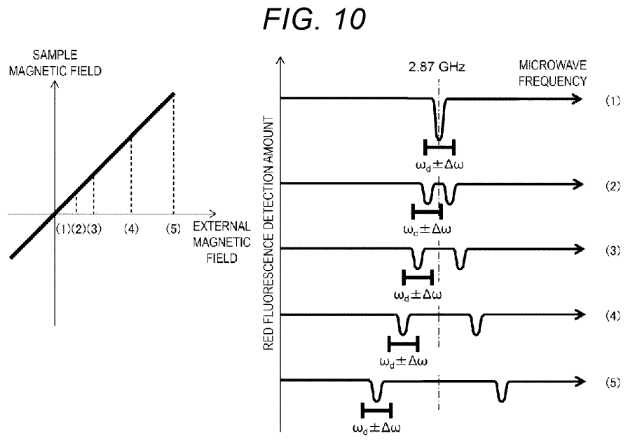

FIG. 9 is a schematic diagram illustrating an example of a result (magnetization curve and ODMR spectrum) of magnetic property measurement according to the invention performed on a commercially available permalloy, and FIG. 10 is a schematic diagram illustrating an example of a result (magnetization curve and ODMR spectrum) of magnetic property measurement according to the invention performed on a commercially available permendur. For simplification of the drawing, the hysteresis in the magnetization curve will be omitted.

A sample in FIG. 9 is a permalloy having a relative magnetic permeability of 180000 and a saturation magnetic flux density of 0.72 T, and a slope of the magnetization curve is large (the gradient is steep) and the magnitude of the sample magnetic field is small because the magnetic permeability is relatively high and the Bs is relatively low. In contrast, a sample in FIG. 10 is a permendur having a relative magnetic permeability of 10000 and a saturation magnetic flux density of 2.45 T, and a slope of the magnetization curve is small (the gradient is gentle) and the magnitude of the sample magnetic field is large because the magnetic permeability is relatively low and the Bs is relatively high.

In any of the samples, it is confirmed that when the external magnetic field is zero, the number of dips of the ODMR spectrum is one at the microwave frequency of 2.87 GHZ, but as the external magnetic field is increased, the Zeeman splitting is increased, and the deviation width of the dip (a frequency difference from 2.87 GHZ) is increased. Since the sample (permendur) in FIG. 10 has a Bs higher than that of the sample (permalloy) in FIG. 9, the measured external magnetic field becomes higher, and the deviation width of the dip also becomes larger.

Even in such samples, in the magnetic property measurement according to the invention, the microwave frequency ω_{d} at the dip position of the ODMR spectrum is estimated, and the frequency sweep width of the microwave is limited to a region in the vicinity of the ω_{d} (ω_{d}±Δω, Δω=0.01 GHZ to 0.05 GHZ). Therefore, the measurement time can be significantly reduced as compared with the related art.

The embodiment described above has been described to facilitate understanding of the invention, and the invention is not limited to the specific configuration described above. For example, a part of a configuration of the embodiment can be replaced with a configuration of the common technical knowledge of those skilled in the art, and the configuration of the common technical knowledge of those skilled in the art can be added to the configuration of the embodiment. That is, in the invention, with respect to a part of the configuration of the embodiment of the present specification, deletion, replacement with other configurations, and addition of other configurations are possible without departing from the technical idea of the invention.

What is claimed is:

1. A magnetic property measurement method for a soft magnetic material, which is a method for measuring a magnetic property of the soft magnetic material by using a diamond NVC sensor, the method comprising:
a measurement condition input step of inputting a measurement condition of the magnetic property;
a magnetic property measurement step of, according to the measurement condition, applying an external magnetic field to a measurement sample of the soft magnetic material, irradiating the diamond NVC sensor disposed in the vicinity of the measurement sample with green laser light and a microwave in a predetermined frequency range, and detecting red fluorescence from the diamond NVC sensor to measure a dip of an optically detected magnetic resonance spectrum; and
a data analysis step of obtaining a center frequency of the dip and calculating a magnetic field of the measurement sample in the external magnetic field based on the center frequency, wherein
the measurement condition includes a range of the external magnetic field H₀ [unit: A/m], a magnetic permeability μₛₘₚ [unit: T·m/A] of the measurement sample, and a predetermined frequency sweep width Δω in the microwave, and
the predetermined frequency range of the microwave in the magnetic property measurement step is a region of “ω_{d}±Δω” based on a microwave frequency ω_{d} [unit: GHz] of the dip obtained from a relational expression of “ω_{d}=2.87±28×μₛₘₚ×H₀” in an environment of 20° C.

2. The magnetic property measurement method for a soft magnetic material according to claim 1, wherein
the measurement condition input step is executed by being divided into
a measurement condition partial input substep of inputting a measurement condition other than the magnetic permeability μₛₘₚ of the measurement sample,
an optically detected magnetic resonance spectrum preliminary measurement substep of, based on the measurement condition in the measurement condition partial input substep, applying the external magnetic field to the measurement sample, measuring the dip of the optically detected magnetic resonance spectrum while irradiating the diamond NVC sensor with the green laser light and the microwave, and obtaining the center frequency of the dip, and
a sample magnetic permeability calculation substep of calculating the magnetic permeability μₛₘₚ of the measurement sample based on the applied external magnetic field, the obtained center frequency of the dip, and the relational expression.

3. The magnetic property measurement method for a soft magnetic material according to claim 2, wherein
the measurement condition further includes a frequency sweep speed of the microwave,
the external magnetic field in the optically detected magnetic resonance spectrum preliminary measurement substep is at least one magnetic field selected from a range of 20% or more and 80% or less of an external magnetic field input in the measurement condition partial input substep, and
irradiation with the microwave in the optically detected magnetic resonance spectrum preliminary measurement substep is performed at a speed of 5 times or more and 10 times or less the frequency sweep speed input in the measurement condition partial input substep.

4. The magnetic property measurement method for a soft magnetic material according to claim 1, wherein
the magnetic property measurement step is executed on “only a region on a side less than 2.87 GHz” or “only a region on a side larger than 2.87 GHZ” of the dip caused by Zeeman splitting.

5. The magnetic property measurement method for a soft magnetic material according to claim 2, wherein
the magnetic property measurement step is executed on “only a region on a side less than 2.87 GHZ” or “only a region on a side larger than 2.87 GHZ” of the dip caused by Zeeman splitting.

6. The magnetic property measurement method for a soft magnetic material according to claim 3, wherein
the magnetic property measurement step is executed on “only a region on a side less than 2.87 GHZ” or “only a region on a side larger than 2.87 GHz” of the dip caused by Zeeman splitting.

7. The magnetic property measurement method for a soft magnetic material according to claim 1, wherein
the predetermined frequency sweep width Δω is 0.01 GHz or more and 0.05 GHz or less.

8. A magnetic property measurement device for a soft magnetic material, which is a device for measuring a magnetic property of the soft magnetic material, the device comprising:
a sample setting mechanism configured to set the soft magnetic material serving as a measurement sample;
a measurement sample magnetic field application mechanism configured to apply an external magnetic field to the measurement sample;
a diamond NVC sensor configured to detect a magnetic field of the measurement sample;
a laser light irradiation mechanism configured to irradiate the diamond NVC sensor with green laser light;
a microwave irradiation mechanism configured to irradiate the diamond NVC sensor with a predetermined microwave;
an optically detected magnetic resonance spectrum measurement mechanism configured to detect red fluorescence from the diamond NVC sensor and measure an optically detected magnetic resonance spectrum; and
a control and data analysis mechanism configured to control the measurement sample magnetic field application mechanism, the laser light irradiation mechanism, and the microwave irradiation mechanism, and perform data analysis based on the optically detected magnetic resonance spectrum measured by the optically detected magnetic resonance spectrum measurement mechanism, wherein
the control and data analysis mechanism is configured to execute
a measurement condition input step of inputting a measurement condition of the magnetic property,
a magnetic property measurement step of, according to the measurement condition, performing application and control of the external magnetic field on the measurement sample, performing irradiation and control of the green laser light and the microwave on the diamond NVC sensor, and performing measurement of a dip of the optically detected magnetic resonance spectrum caused by the red fluorescence from the diamond NVC sensor, and
a data analysis step of obtaining a center frequency of the dip and calculating the magnetic field of the measurement sample in the external magnetic field based on the center frequency,
the measurement condition includes a range of the external magnetic field H₀ [unit: A/m], a magnetic permeability μₛₘₚ [unit: T·m/A] of the measurement sample, and a predetermined frequency sweep width Δω in the microwave, and
the predetermined frequency range of the microwave in the magnetic property measurement step is a region of “ω_{d}±Δω” based on a microwave frequency ω_{d} [unit: GHz] of the dip obtained from a relational expression of “ω_{d}=2.87±28×μₛₘₚ×H₀” in an environment of 20° C.

9. The magnetic property measurement device for a soft magnetic material according to claim 8, wherein
the measurement condition input step is executed by being divided into
a measurement condition partial input substep of inputting a measurement condition other than the magnetic permeability μₛₘₚ of the measurement sample,
an optically detected magnetic resonance spectrum preliminary measurement substep of, based on the measurement condition in the measurement condition partial input substep, applying the external magnetic field to the measurement sample, measuring the dip of the optically detected magnetic resonance spectrum while irradiating the diamond NVC sensor with the green laser light and the microwave, and obtaining the center frequency of the dip, and
a sample magnetic permeability calculation substep of calculating the magnetic permeability μₛₘₚ of the measurement sample based on the applied external magnetic field, the obtained center frequency of the dip, and the relational expression.

10. The magnetic property measurement device for a soft magnetic material according to claim 9, wherein
the measurement condition further includes a frequency sweep speed of the microwave,
the external magnetic field in the optically detected magnetic resonance spectrum preliminary measurement substep is at least one magnetic field selected from a range of 20% or more and 80% or less of an external magnetic field input in the measurement condition partial input substep, and
irradiation with the microwave in the optically detected magnetic resonance spectrum preliminary measurement substep is performed at a speed of 5 times or more and 10 times or less the frequency sweep speed input in the measurement condition partial input substep.

11. The magnetic property measurement device for a soft magnetic material according to claim 8, wherein
the magnetic property measurement step is executed on “only a region on a side less than 2.87 GHZ” or “only a region on a side larger than 2.87 GHZ” of the dip caused by Zeeman splitting.

12. The magnetic property measurement device for a soft magnetic material according to claim 9, wherein
the magnetic property measurement step is executed on “only a region on a side less than 2.87 GHz” or “only a region on a side larger than 2.87 GHZ” of the dip caused by Zeeman splitting.

13. The magnetic property measurement device for a soft magnetic material according to claim 10, wherein
the magnetic property measurement step is executed on “only a region on a side less than 2.87 GHz” or “only a region on a side larger than 2.87 GHZ” of the dip caused by Zeeman splitting.

14. The magnetic property measurement device for a soft magnetic material according to claim 8, wherein
the predetermined frequency sweep width Δω is 0.01 GHz or more and 0.05 GHz or less.
